(19) United States
(12) Patent Application Publication
(10) Pub. No.: US 2026/0227053 A1
(43) Pub. Date: Aug. 6, 2026

(54) A LINEAR LIGHTING UNIT HAVING A ATLEAST TWO ELONGATED LIGHTS SOURCES THAT ARE MOVEABLE WITHIN A HOUSING

(71) Applicant: SIGNIFY HOLDING B.V., EINDHOVEN (NL)

(72) Inventors: ANNA WILHELMINA MARIA DE BEST, VELDHOVEN (NL); MARCELLINUS PETRUS CAROLUS MICHAEL KRIJN, EINDHOVEN (NL); BARTEL MARINUS VAN DE SLUIS, EINDHOVEN (NL); LEENDERT TEUNIS ROZENDAAL, EINDHOVEN (NL)

(21) Appl. No.: 19/151,442

(22) PCT Filed: Dec. 20, 2023
(86) PCT No.: PCT/EP2023/086883

§ 371 Date: Jul. 28, 2025

(30) Foreign Application Priority Data
Jan. 9, 2023 (EP) 23150678.3

(51) Int. Cl. F21S 8/00; F21S 4/28; F21V 14/02; F21V 21/14; F21Y 103/10; H05B 45/20

(52) U.S. Cl. CPC F21V 14/02; F21S 4/28; F21V 21/14; F21Y 2103/10

(57) ABSTRACT

The present invention relates to a linear lighting unit (1) having a longitudinal extension (L1) and arranged for providing a unit light. The linear lighting unit (1) comprises a first linear elongated light source (2) having a longitudinal extension (L2) being substantially parallel to the longitudinal extension (L1) of the linear lighting unit (1). The first linear elongated light source (2) comprises a plurality of first LEDs (4) arranged along the longitudinal extension (LI) of the first linear elongated light source (2). The linear lighting unit further comprises a second linear elongated light source (3) having a longitudinal extension (L3) being substantially parallel to the longitudinal extension (L1) of the linear lighting unit (1). The second linear elongated light source (3) comprises a plurality of second LEDs (5) arranged along the longitudinal extension (L3) of the second linear elongated light source (3). The plurality of first LEDs (4) is arranged to emit a beam of first light (4′) in a first direction (A). The second linear elongated light source (3) preferably is at least partially arranged in the beam of first light (4′) and is arranged to emit a beam of second light (5′) in a second direction (B).

### TECHNICAL FIELD

The present invention relates to a linear lighting unit for providing decorative light effect.

### BACKGROUND

Linear luminaires for wall-washing are well-known, such as the ColorKinetics PureStyle or the Hue Signe. Such luminaires contain a row of LEDs providing light of different colors in order to create either a uniform color on the wall, or a color variation along the longitudinal direction of the linear light source (1-D color pattern).

If a color gradient in the direction perpendicular to the longitudinal direction, i.e. the transverse direction, of the luminaire is desired, an additional linear light source is required. An example of a linear wall washer with a 1-D transverse color gradient is the NatureConnect Lightscape. Dedicated optics are needed to create the desired gradient (smooth or sharp) from one color to another color in the transverse direction of the luminaire. Such optics add to the total manufacturing cost of the luminaire.

When n linear light sources are used, typically only n-1 color transitions can be made in the transverse direction (n being an integer).

Therefore, there is a need to provide a linear lighting unit having improved performance. In particular, it is desired to provide a linear lighting unit that enables a large number of colour transitions in the transverse direction.

### SUMMARY

The present invention thus provides such a linear lighting unit and is set out in the appended set of claims. According to the present invention, using n linear light sources in the lighting unit allows for up to 3n-1 colored areas (with 3n-2 color transitions), which is significantly greater compared to the lighting units known in the art. Further, a 2-D pattern can be created if segmented linear light sources are used, as will be explained in greater detail below.

A linear lighting unit according to the present invention has a longitudinal extension and is arranged for providing a unit light. The linear lighting unit according to the present invention comprises a first linear elongated light source having a longitudinal extension being substantially parallel to the longitudinal extension of the linear lighting unit. By the term “elongated” is understood as having a longitudinal extension being substantially greater that the transverse extension perpendicular to the longitudinal extension, e.g. at least 3 greater, such as 5 times greater, preferably 10 times greater, more preferably 20 times greater. By the term “substantially parallel” is understood parallel or slightly deviating from parallel, e.g. deviating by at most 5°.

The first linear elongated light source comprises a plurality of first LEDs arranged along the second longitudinal extension of the first linear elongated light source.

The plurality of LEDs may comprise at least 10 LEDs, preferably at least 30 LEDs, more preferably at least 50 LEDs. The LEDs may be distributed in one single row, in several parallel rows, in a zig-zag pattern, in a wave pattern or the like. The LEDs may be evenly distributed along the second longitudinal extension of the first linear elongated light source, or may be concentrated in particular portions of the first linear elongated light source.

The term “LED” as used in the context of the present invention implies any type of LED known in the art, such as inorganic LED(s), organic LED(s), polymer/polymeric LEDs, violet LEDs, blue LEDs, optically pumped phosphor coated LEDs, optically pumped nano-crystal LEDs, RGB(AW) LED (-nodes). As used herein, the term “LED” can encompass a bare LED die arranged in a cup, which may be referred to as a LED package. When UV-C light is used, the LED may be mounted in a cavity covered in a non-contact manner by an emission window made from quartz/fused silica.

The linear lighting unit according to the present invention further comprises a second linear elongated light source spacingly arranged at a spacing (measured in a transverse direction), next to the first linear elongated light source (hence, not lying in line with each other) and having a third longitudinal extension being substantially parallel to the longitudinal extension of the linear lighting unit. It is implicitly understood that the second linear elongated light source is also substantially parallel to the first linear elongated light source. The second linear elongated light source comprises a plurality of second LEDs arranged along the third longitudinal extension of the second linear elongated light source. The plurality of LEDs may comprise at least 10 LEDs, preferably at least 30 LEDs, more preferably at least 50 LEDs. The LEDs may be distributed in one single row, in several parallel rows, in a zig-zag pattern, in a wave pattern or the like. The LEDs may be evenly distributed along the third longitudinal extension of the second linear elongated light source, or may be concentrated in particular portions of the second linear elongated light source.

It should be noted that the linear lighting unit according to the present invention may comprise a plurality of linear elongated light sources. By the term “plurality” is in the context of the present invention understood more than two, for example three, four, five, six, ten or more.

The plurality of first LEDs is arranged to emit first light, initially as a beam, for example in a first direction, which is in the context of the invention referred to as “initial beam of first light”. Said initial beam of first light might be directed directly or indirectly, for example via a reflective surface, to the target area, said initial beam of first light when reflected by said reflective surface, which could for example be a wall and/or base of a housing which accommodates the light source(s), is then referred to as “reflected beam of first light”.

The unit light emitted by the linear lighting unit of the present invention thus comprises the first light emitted by the first linear elongated light source and the second light emitted by the second linear elongated light source. In order to increase rigidity of the elongated light sources, the first and/or the second light source may be attached to a rigid carrier. The carrier may be transparent. Further, the carrier may have optical properties, such as diffusive properties, or may constitute an optical element, such as a lens.

It should be noted that the positions of the first and/or the second elongated light sources in relation to each other (and to the optional housing are) variable, i.e. that the first linear elongated light source and/or the second linear elongated light source is movable for changing a mutual position between the first and second linear elongated light source such that a different illumination pattern of the illumination on the target area is provided by the unit light. For instance, the first and/or the second elongated light sources may be moved, for example rotated over their respective longitudinal extension and/or shifted, relatively to each other in a direction perpendicular to the longitudinal extension of the lighting unit. Hence, the linear lighting unit may have the feature that at least one of the first and second elongated light source is rotatable over its respective longitudinal extension. Alternatively or additionally, the linear lighting unit may have the feature that at least one of the first and second light source is shiftable in the transverse direction. Via rotation and/or shifting one light source with respect to the other light source mutual alignment of the directions of the optical paths of the first beam of light and the second beam of light can be realized. By the term “alignment” is meant that the angle between the first and the second direction of the optical paths is below 30°, preferably below 15°, more preferably below 5°. In particular, the first direction may be (substantially) parallel to the second direction, and/or may coincide with the second direction. Furthermore, typically the second linear elongated light source may be completely arranged in the beam of first light when viewed in projection along/over the first longitudinal extension, which means that viewed in said projection along L1 the beam of first light passes the second linear light source on either side of the second linear light source. Hence, this could be seen as that the beam of the first light is purposely aimed at the second light source. Alternatively, the first direction may be opposite to the second direction, via reflection said first direction might subsequently be inversed and substantially aligned with the second direction. Hence, possible other configurations are:
said first direction (A) is substantially aligned with said second direction (B);
said first direction (A) coincides with said second direction (B);
said first direction (A) is substantially parallel to said second direction (B);
said first direction (A) is opposite to said second direction (B), in such a configuration, the first and the second light sources are arranged in a back-to-back configuration. The plurality of first LEDs is arranged to emit first light as an initial beam of first light in a first direction, said initial beam of first light is subsequently directed via a reflective surface, for example via a base portion and/or a wall portion of a housing when said light sources are accommodated in said housing of said linear lighting unit, as reflected beam of first light; and
said first direction (A) and/or said second direction (B) is substantially perpendicular to a light exit window when said light sources are accommodated in a housing of said linear lighting unit. Optionally, a wall portion of the housing may further comprise a diffuser.

The lighting unit of the present invention may be used as a wall-washer being free from a housing. Alternatively, or additionally, it can also be used for task or accent lighting, whereby one or both of the light sources provide linear white functional light effect(s) on the task or presentation area, while the other light sources provide a colored ambience effect.

The linear lighting unit may have the feature that at least one of the first and second elongated light source is rotatable over its respective longitudinal extension. In order to increase versatility of the lighting unit of the present invention, the first and/or the second linear elongated light source may be rotatable around its longitudinal extension. According to such an embodiment, the user may choose to rotate the first and/or the second light sources such that the optical path of the first light does not interfere with the second light source.

The linear lighting unit may have the feature that said beam of first light has a first beam angle, α, in a transverse direction transverse to the longitudinal extension, wherein 30°<=α<=180°, such as 45°<=α<=120°, for example α=75° or 100°, wherein said beam of second light has a second beam angle, β in said transverse direction, wherein 30°<=β<=180°, such as 45°<=β<=120°, for example β=70° or 110°, and wherein at least one of the first and second elongated light source is rotatable within a respective rotation angle range, Φᵣ, wherein 5°<=Φᵣ<=180°, such as 10°<=Φᵣ<=120°. Preferably α<=β. As mentioned, the beam of first light may have a first beam angle and the beam of second light may have a second beam angle. The first beam angle may be smaller than the second beam angle. In such an embodiment, a desired effect may be achieved wherein the first light and the second light do not mix.

The linear lighting unit may have the feature that during operation of the linear lighting unit for any mutual rotational orientation of the first and second linear elongated light source in said rotation angle range, there is ((only) partial) overlap between at least one of the beam of second light and the optical path of the beam of first light in the transverse direction. Due to said (partial) overlap being always present, attractive gradual color transitions/patterns may be obtained when the first and second light source emit light of different colors.

The linear lighting unit may have the feature that at least one of the first and second light source is shiftable in the transverse direction. In order to increase versatility of the lighting unit of the present invention, the first and/or the second linear elongated light source may be shiftable in the transverse direction. According to such an embodiment, the user may choose to shift the first and/or the second light sources relatively with respect to one another such that the optical path of the first light does not interfere with the second light source.

The linear lighting unit may have the feature that in operation of the linear lighting unit said second linear elongated light source is at least partially arranged in the optical path of said beam of first light. Thus, the second linear elongated light source is at least partially arranged in the initial beam of first light and/or in the reflected beam of first light and is arranged to emit a beam of second light in a second direction. In other words, the second linear elongated light source may be completely arranged in the optical path of the first light emitted by the first linear elongated light source. Consequently, the light from the first linear elongated light source is blocked in the angular range that is occupied by the second linear elongated light source. The extent of the blocked angular range depends on the size and the position of the second linear elongated light source.

The linear lighting unit may have the feature that the second linear elongated light source has a backside which is provided with a light reflective diffuser, for example a powder coating or reflective foil, facing the first linear elongated light source. Thus light losses are counteracted and smoothness of gradual changes in the (colored) illumination of the target area is improved.

The linear lighting unit may have the feature that said beam of first light and said beam of second light mutually differ in at least one of color, color-temperature, CT, and correlated color temperature, CCT. The color and/or color-temperature and/or correlated color temperature of the first light may be different from the color and/or color-temperature and/or correlated color temperature of the second light. In particular, the first light may have a first colour C1 and the second light may have a second colour C2. When the second light source is in the optical path of the first source, and the light of the first light source is further blocked by the (side) wall portions of the housing, the color scheme of the unit light would change from C2 to a mix of C1 and C2, then to C2, then to a mix of C1 and C2, and finally to C2. In the context of the invention, the expression “optical path” is to be understood as the main or average propagation direction of a light beam as issued by the elongated light source. Said light beam typically having a full width at half maximum (FWHM) or beam angle which is in the order of at least 30 degrees, for example 60 degrees or 120 degrees, or even up to 180 degrees.

The color transitions may be relatively sharp. In order to provide smoother transitions, additional optics may be applied. In particular, a diffuser may be arranged in relation to one or both light sources or elsewhere in the optical path of the first and/or the second light. The plurality of first LEDs and/or the plurality of second LEDs may comprise at least two LEDs of mutually different colour, colour temperature or correlated colour temperature (CCT). Further, the first and/or the second linear elongated light source may have fixed colour or may be colour-variable. The linear LED node array of the first and/or the second linear elongated light source may also support pixelated color control.

The linear lighting unit may have the feature that at least one of said plurality first LEDs and said plurality of second LEDs is color controllable. Thereto, typically such a LED (also referred to as LED node of LED element) comprises multiple LED dies or multiple primary LEDs of different color. For example, the linear lighting unit may have the feature that said plurality of first LEDs and/or said plurality of second LEDs comprises at least two LEDs of mutually different of color, color-temperature, CT, and/or correlated color temperature, CCT. Alternatively or additionally, the linear lighting unit may have the feature that said first and/or said second linear elongated light source is color-variable.

The linear lighting unit may have the feature that it further comprises a housing, wherein the housing comprises an inner compartment being delimited by a base portion, a light exit window arranged opposite and at a distance from said base portion, and a wall portion connecting said base portion and said light exit window, wherein said inner compartment is arranged to accommodate said first and/or said second linear elongated light source. Preferably, both the first and the second linear elongated light sources are arranged in the inner compartment of the housing.

In the context of the invention a light exit window is to be interpreted as any area, volume, or material which allow light to pass through it. The housing may be a hermetic housing. The housing may have any geometrical shape. The housing may be formed as a cuboid, where at least one face of the cuboid may act as a light exit window from where arrangement light can be emitted. The housing may further comprise an attachment surface arranged to be positioned on the surface to which the housing is to be attached, such as a ceiling, a floor, a wall, a table, or another suitable surface in a room.

It should be noted that in an embodiment when the housing is a cuboid, the base portion and the light exit window may be formed by two opposite sides of the cuboid, while the wall portion may be formed by one or both of the other two opposite sides.

It is understood that the housing is elongated having a longitudinal extension and a transverse extension. Preferably, the longitudinal extension of the housing is equal to or slightly greater, for example up to 10% greater, than the longitudinal extension of the first and the second linear elongated light sources. The cross-section of the housing in the transverse direction thereof may be substantially U-shaped, substantially V-shaped or the like. At least a portion of the surface of the inner compartment may be absorbing or reflective. For example, at least one of the base portion and wall portion have a reflectivity of at least 70% for visible light, preferably at least 80%, more preferably at least 90%, such as 92%.

The linear lighting may have the feature that both the first and the second linear elongated light source are arranged by a respective spacing in the transverse direction from said wall portion, and wherein said second elongated linear light source is arranged closer to said light exit window than said first elongated linear light source. It is thus enabled that an increased number of screening portions of the beam of first light is attained, which typically results in an increased number of desired (gradual) (color) transitions of the illumination of the target area.

The linear lighting unit may have the feature that the wall portion is blocking at least one of a part of the beam of the first light and a part of the beam of second light for obtaining a desired cut-off angle or screening angle of at least one of the beam of first light and beam of second light, and/or for further control of the (mixing) of the illumination patterns of the first and second light beam. Further the light from the first light source (and from the second light source) may be partly blocked by the wall portions of the housing, for example to obtain a desired cut-off angle or screening angle of the first and/or second light beam, and/or to further control the (mixing) of the illumination patterns of the first and second light beam. To counteract too much blocking, the direction of the beam of first light and/or the direction of the beam of second light may be substantially perpendicular to the light exit window. When the light exit window is free from any optical element, the housing (and lighting unit) is relatively cheap. Still, an interesting and attractive illumination of the lighting unit is obtained because of the mutual position of the linear elongated light sources and the light screening effect by the wall portion of the housing. Alternatively or additionally the wall portions of the housing may be transflective, i.e. in that wall portions are made of a material that at the same location is partially light reflective, for example for at least 25%, and partially light transmissive, for example for at least 25%.

The linear lighting unit may have the feature that said linear lighting unit further comprises a base support, and wherein at least one of said linear light sources comprise a respective end portion and is rotatably and/or shiftable connected to said base support via its respective end portion for enabling rotation of said light source over the respective longitudinal extension and/or shift of said light source in the transverse direction. Such a base support typically can simultaneously function as a base for the lighting unit embodied as an upright, standing floor lamp and offers a convenient manner for setting a desired illumination pattern on a target area. Said base support can, for example, be provided with slots for accommodating a mechanical (and optionally also electrical) connector of the light source and to enable the shift of the light source over the base support.

The linear lighting unit may have the feature that said linear lighting unit further comprises a third linear elongated light source having a longitudinal extension being substantially parallel to said longitudinal extension of said linear lighting unit, said third linear elongated light source comprising a plurality of third LEDs arranged along said longitudinal extension of said third linear elongated light source, wherein said plurality of third LEDs is arranged to emit a beam of third light, and wherein said third linear elongated light source is at least partially arranged in said beam of said first and/or said second light.

As mentioned above, the linear lighting unit according to the present invention may further comprise a third linear elongated light source having a longitudinal extension being substantially parallel to the longitudinal extension of the linear lighting unit. If present, the third linear elongated light source comprises a plurality of third LEDs arranged along the longitudinal extension of the third linear elongated light source. The plurality of third LEDs is arranged to emit a beam of third light in a third direction. The third linear elongated light source may at least partially be arranged in the optical path of the first and/or the second light.

In order to create even richer linear effect patterns, three or more parallel linear elongated light sources may be used. For instance, a first and a second elongated light sources may be arranged next to each, while a third elongated light source may be arranged in the optical path of the first and the second light. Further, a plurality or linear elongated light sources may be arranged in the same plane such that they emit light along the same line. In such an embodiment, for example when arranged in a housing, each linear elongated light source except for the one closest to the base portion will be positioned in the optical path of the light emitted by the preceding linear elongated light source. Such an embodiment provides the advantage of a relatively large number of colour and/or colour temperature transitions that may be obtained.

The linear lighting unit may have the feature that said linear lighting unit further comprises a control unit and a detecting element arranged to provide input to said control unit. The linear lighting unit according to the present invention may comprise a control unit. Each of the light sources may be controlled individually. The control unit may be configured to control the first light source in relation to the second and/or third light source. In particular, the first light source may be operating when the second and/or the third light sources are switched off.

In one mode of operation, the colors of the light emitted by the light sources may be changing dynamically, such as to arrive at a dynamical spatial pattern of light. Such pattern and its dynamics may be selected from a number of presets.

In another mode of operation, the colors emitted by the light sources are similar while the light output of the light sources is adapted such as to obtain a desired spatial profile. For example, switching on only the light source emitting the light not being blocked by the other light sources will results in a light pattern with no transitions.

If pixelated light sources are used, a 2D pattern may be obtained.

According to the present invention, the lighting unit may provide transitions wherein the linear light sources “exchange” their colors, such that the projected colors remain the same, while the pattern (gradually) switches between an initial pattern and its inverse pattern. Such an embodiment provides an aesthetically appealing effect.

The lighting unit according to the present invention may also receive input on the presence or relative position of a user and adjust the light output accordingly. To this end, the lighting unit may comprise a presence and/or motion sensor arranged to provide input to the control unit. For example, if a user comes close, one of the light sources may desaturate its color (e.g. the desaturation may depend on the detected proximity), or switch to a pre-defined white color output.

The user may also be offered the opportunity to de-activate the linear color pattern (e.g. in the lighting control app), in which case each of the linear sources will be controlled to render the same light color. The brightness of each of the sources may be adjusted to a default level such that the linear pattern will no longer be visible to the user.

The linear lighting unit may be a washer, such as a wall washer, a ceiling washer, or a floor washer. The wall washer is normally configured to illuminate a vertical surface, while the floor and the ceiling washer are normally configured to illuminate a horizontal surface.

The lighting unit of the present invention may be a wall washer being arranged at any other surface within the room, such as on a wall, on the floor or on a surface of a piece of furniture.

A plurality of lighting units may be arranged at different locations within the same room. The lighting unit according to the present invention may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, (outdoor) road lighting systems, urban lighting systems, green house lighting systems, horticulture lighting, digital projection, or LCD backlighting. Considering the above, the present invention provides an improved lighting unit that provides a possibility for obtaining a large number of colour transitions.

### BRIEF DESCRIPTION OF THE DRAWINGS

Embodiments of the invention will now be described by way of example with reference to the accompanying drawings, of which:

FIGS. 1a and 1b illustrate a lighting unit according to the present invention;

FIG. 1c depicts a transversal cross-section of the lighting unit according to the present invention;

FIG. 1d depicts a color pattern formed of the surface being illuminated by the lighting unit depicted in FIG. 1c;

FIG. 2a depicts an embodiment of the lighting unit according to the present invention, wherein the first light is emitted in a first direction being opposite to the second direction of the second light;

FIG. 2b illustrates a light pattern obtained by the lighting unit shown in FIG. 2a;

FIGS. 3a and 3b illustrate another embodiment of the lighting unit according to the present invention;

FIGS. 4a and 4b depict a lighting arrangement comprising three light sources;

FIGS. 5a and 5b depicts respectively a side view and a top view of another embodiment of a lighting unit according to the invention.

FIG. 6 illustrates a plurality of lighting units comprising rotatable light sources and being arranged within a room.

All the figures are schematic, not necessarily to scale, and generally only show parts which are necessary in order to elucidate embodiments of the present invention, wherein other parts may be omitted or merely suggested.

### DETAILED DESCRIPTION OF PREFERRED EMBODIMENTS

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments of the present invention are provided by way of example so that this disclosure will convey the scope of the invention to those skilled in the art. In the drawings, identical or similar reference numerals denote the same or similar components having a same or similar function, unless specifically stated otherwise.

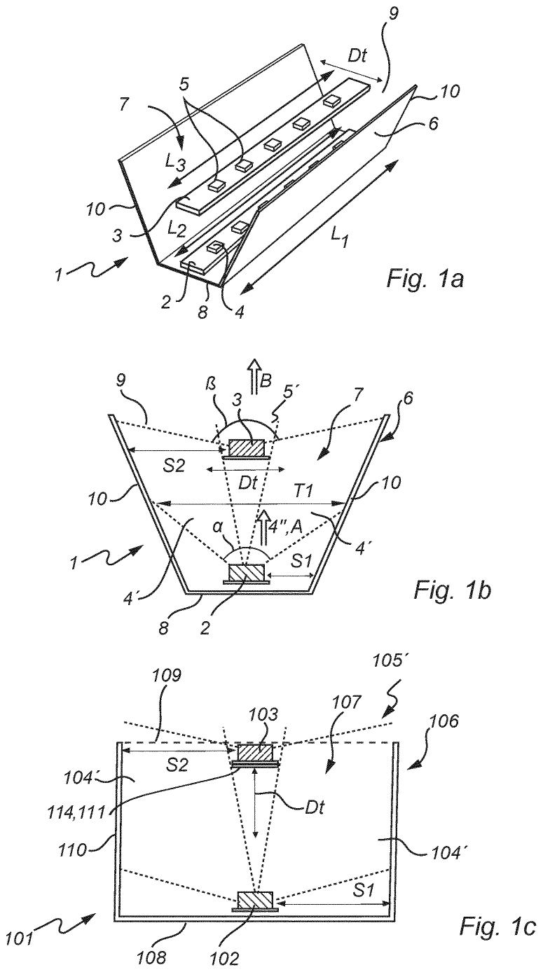

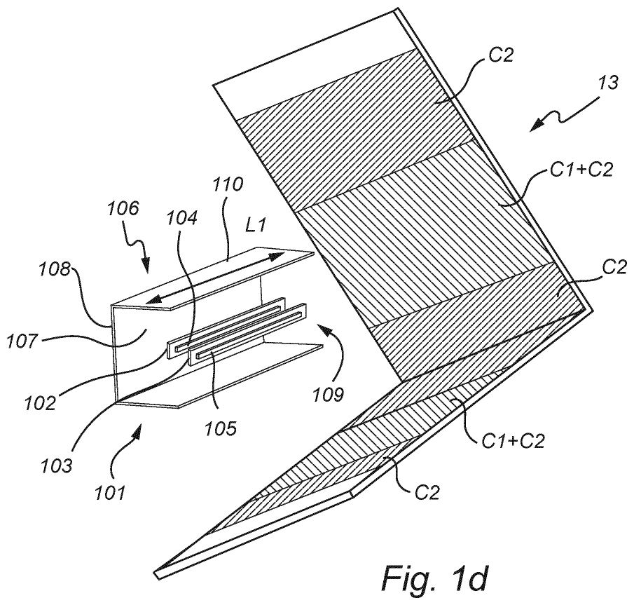

FIGS. 1a and 1b illustrate a perspective and transversal cross-sectional view of a linear lighting unit 1, respectively. The lighting unit 1 has a longitudinal extension L1 and is arranged for providing a unit light. The linear lighting unit 1 comprises a first linear elongated light source 2 having a longitudinal extension L2 being substantially parallel to the longitudinal extension L1 of the linear lighting unit 1. The first linear elongated light source 2 comprises a plurality of first LEDs 4 arranged along the longitudinal extension L2 of the first linear elongated light source 2. The LEDs 4 are evenly distributed in one single row.

The linear lighting unit 1 further comprises a second linear elongated light source 3 having a longitudinal extension L3 being substantially parallel to the longitudinal extension L1 of the linear lighting unit 1. It is implicitly understood that the second linear elongated light source 3 is also substantially parallel to the first linear elongated light source 2. The second linear elongated light source 3 comprises a plurality of second LEDs 5 arranged along the longitudinal extension L3 of the second linear elongated light source 3. The LEDs are evenly distributed along the longitudinal extension L3 of the second linear elongated light source 3.

The plurality of first LEDs 4 and/or the plurality of second LEDs 5 may comprise at least two LEDs of mutually different colour, CT or CCT. Further, the first and/or the second linear elongated light source 2, 3 may have fixed colour or may colour-variable.

The linear lighting unit 1 further comprises a housing 6 comprising an inner compartment 7 being delimited by a base portion 8, a light exit window 9 arranged at a distance from the base portion 8, and a wall portion 10 connecting the base portion 8 and the light exit window 9. The inner compartment 7 is arranged to accommodate the first and the second linear elongated light sources 2, 3. The first elongated linear light source 2 is in a fixed position at a distance S1 from the wall portion 10. The second elongated linear light source 3 is arranged at a distance S2 from the wall portion 10, yet is shiftable in a direction Dt transverse to its elongated extension L3 and essentially parallel to the light exit window 9.

The housing 6 is elongated having a longitudinal extension L1 and a(n average) transverse extension T1 much smaller than L1, in the figure L1 is about four times larger than the transverse extension T1. Preferably, the longitudinal extension of the housing L1 is equal to or greater than the longitudinal extension L2 and L3 of the first and the second linear elongated light sources 2, 3.

The plurality of first LEDs 4 is arranged to emit a beam of first light 4′ along an optical path 4″ in a first direction A, said beam of first light has a first beam angle a of about 105°. According to the present invention, the second linear elongated light source 3 is at least partially arranged in the beam of first light 4′ and is arranged to emit a beam of second light 5′ in a second direction B and has a second beam angle β of about 160°. In other words, the second linear elongated light source 3 is mounted in the optical path of the first light 4′ emitted by the first linear elongated light source 2. Consequently, the light from the first linear elongated light source 2 is blocked in the angular range that is occupied by the second linear elongated light source 3. The extent of the blocked angular range depends on the size and the position of the second linear elongated light source 3.

The unit light emitted by the linear lighting unit 1 of the present invention thus comprises the first light 4′ emitted by the first linear elongated light 2 source and the second light 5′ emitted by the second linear elongated light source 3. The first direction A coincides with the second direction B. The first direction A and the second direction B are substantially perpendicular to the light exit window 9.

The embodiment depicted in FIG. 1c is analogous to the embodiment shown in FIGS. 1a and 1b, yet with a different shape of the housing. The lighting unit 101 comprises a first linear elongated light source 102. The first linear elongated light source 102 comprises a plurality of first LEDs 104 (not shown) arranged along the longitudinal extension of the first linear elongated light source 102. The linear lighting unit 101 further comprises a second linear elongated light source 103 having a longitudinal extension being substantially parallel to the longitudinal extension of the linear lighting unit 101. It is implicitly understood that the second linear elongated light source 103 is also substantially parallel to the first linear elongated light source 102. The second linear elongated light source 103 comprises a plurality of second LEDs 105 (not shown) arranged along the longitudinal extension of the second linear elongated light source 103.

The linear lighting unit 101 further comprises a housing 106 comprising an inner compartment 107 being delimited by a base portion 108, a light exit window 109 arranged at a distance from the base portion 108, and a wall portion 110 connecting the base portion 108 and the light exit window 109. The inner compartment 107 is arranged to accommodate the first and the second linear elongated light sources 102, 103. The second elongated linear light source 3 is arranged at a(n essentially fixed) second distance S2 from the wall portion 10, yet is shiftable in a transverse direction Dt transverse to the third elongated direction L3 and essentially perpendicular to the light exit window 9. The first elongated linear light source 2 is in a fixed position at a first distance S1 from the wall portion 10.

As mentioned above, the color and/or color-temperature (CT) and/or correlated color temperature (CCT) of the first light 4′ may be different from the color and/or color-temperature and/or correlated color temperature (CCT) of the second light 5′. In particular, the first light 4′ may have a first colour C1 and the second light 5′ may have a second colour C2. The unit light emitted by the lighting unit 101 according to such an embodiment in the transverse direction being perpendicular to the longitudinal extension L1 of the light sources 102, 103 would thus change at a target area 13 from C2 to a mix of C1 and C2, then to C2, then to a mix of C1 and C2, and finally to C2, as depicted in FIG. 1d.

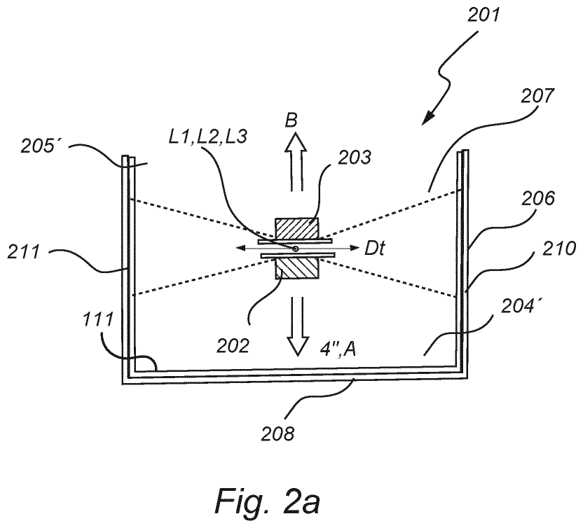

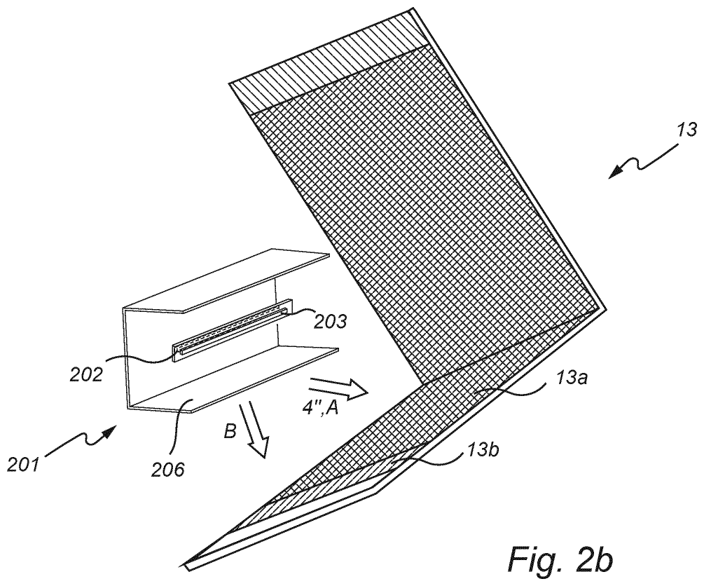

In the embodiment depicted in FIG. 2a, the first direction A of the first light 204′ following optical path 4″ and emitted by the first light source 202 of the lighting unit 201 is opposite to the second direction B of the second light 205′ emitted by the second light source 203. The base portion 208 and the wall portion 210 of the housing 206 have an inner surface 211 facing the inner compartment 207 and is reflective as said inner surface 211 is provided with a diffuse reflector 111. The first light source 202 emits an initial beam of first light 204′ in a first direction A, said initial beam of first light 204′ is subsequently directed via said diffuse reflector 111 provided at the base portion 208 and a wall portion 210 of the housing 206, as reflected beam of first light 204′. Thus, the first light 204′ will thus be reflected by the inner compartment, such that the second light source 203 is arranged in the optical path 4″ of the beam of the first light 204″. Both the first and second elongated linear light source 2, 3 are shiftable in the transverse direction Dt transverse to the elongated extensions L1, L2, L3, which all are parallel. The light distribution provided by such a lighting unit at target area 13 is depicted in FIG. 2b for the given positions of the first and second elongated light sources 2, 3 as shown in FIG. 2a. The beam of first light 204′ in direction a along optical path 4″ illuminates at least a first part 13a of said target area 13, and the beam of second light 205′ in direction B illuminates at least a second part 13b of said target area 13.

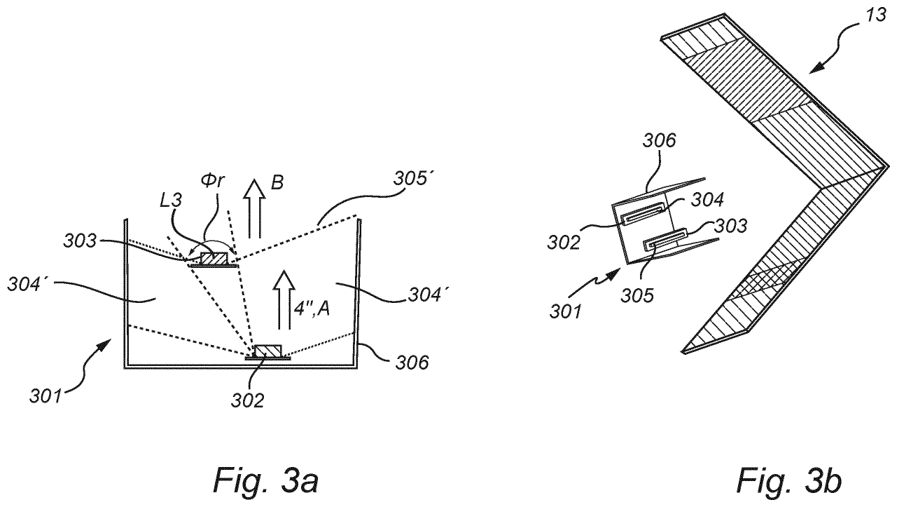

FIG. 3a illustrates yet another embodiment of the lighting unit 301. The plurality of first LEDs 304 is arranged to emit a beam of first light 304′ in a first direction A along an optical path 4″. According to the present invention, the second linear elongated light source 303 is at least partially arranged in the beam of first light 304′ and is arranged to emit a beam of second light 305′ in a second direction B. As shown in FIG. 3a, the first elongated light source 302 and the second elongated light source 303 are arranged parallel to each other, yet offset from each other. Put differently, the first and the second light sources are arranged in parallel planes. Yet, the second elongated light source 303 is rotatable over its elongated extension L3 within a respective rotation angle range Φᵣ, wherein Φᵣ is about 135°. The light pattern provided by the lighting unit 301 on target are 13 as shown in FIG. 3a is depicted in FIG. 3b.

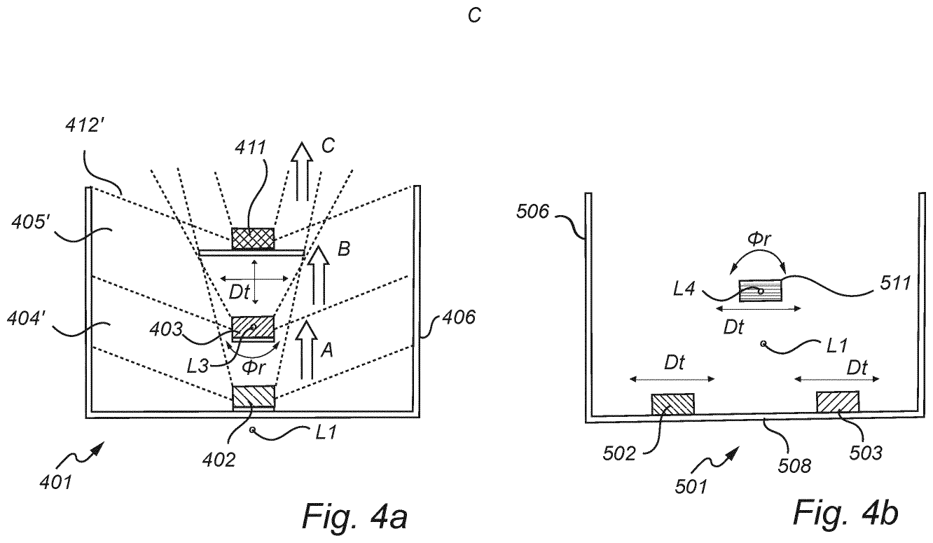

The linear lighting unit 401 shown in FIG. 4a comprises a first linear elongated light source 402 having a longitudinal extension being substantially parallel to the longitudinal extension of the linear lighting unit 401, and a second linear elongated light source 403 having a longitudinal extension being substantially parallel to the longitudinal extension of the linear lighting unit 401. It is implicitly understood that the second linear elongated light source 403 is also substantially parallel to the first linear elongated light source 402. The second linear lighting source 403 is rotatable over its longitudinal extension L3 (not indicated) over a rotation angle range Φᵣ of about 90°. The lighting unit 401 further comprises a third linear elongated light source 411 having a longitudinal extension being substantially parallel to the longitudinal extension of the linear lighting unit 401. The third linear elongated light source 411 is shiftable in transverse directions Dt perpendicular to the elongated extension L1 of the lighting unit 401. The third lighting unit 411 comprises a plurality of third LEDs 412 (not shown) arranged along the longitudinal extension of the third linear elongated light source 401. The plurality of third LEDs 412 is arranged to emit a beam of third light 412′ in a third direction C. The third direction C may coincide with the first and/or the second direction A and B. The third direction C may be opposite to the first and/or the second direction. A, B. The third linear elongated light source 411 is arranged in the optical path of the first and/or the second light 404′, 405′.

Yet another embodiment of the lighting unit 501 comprising three light sources is shown in FIG. 4b accommodated in a housing 506. The first and the second light sources 502, 503 are arranged parallel to each other in the transversal plane and shiftable in transverse directions Dt over the base portion 508 of the housing 506. The third light source 511 is arranged offset relative the first and the second light sources 502, 503 and is rotatable over its elongated extension L4 over a rotation angle range Φᵣ of about 120°. It should be mentioned that if the first and the second light sources emit red and blue light, respectively, and the third light source emits green light, the fluxes of the three light sources may be tuned to obtain desired (white) colour in the central portion of the illuminated target area.

In order to create even richer linear effect patterns, three or more parallel linear elongated light sources may be used. For instance, a first and a second elongated light sources may be arranged next to each, while a third elongated light source may be arranged in the optical path of the first and the second light. Further, a plurality or linear elongated light sources may be arranged in the same plane such that they emit light along the same line. In such an embodiment, each linear elongated light source except for the one closest to the base portion will be positioned in the optical path of the light emitted by the preceding linear elongated light source. Such an embodiment provides the advantage of an extremely large number of colour and/or colour temperature transitions that may be obtained.

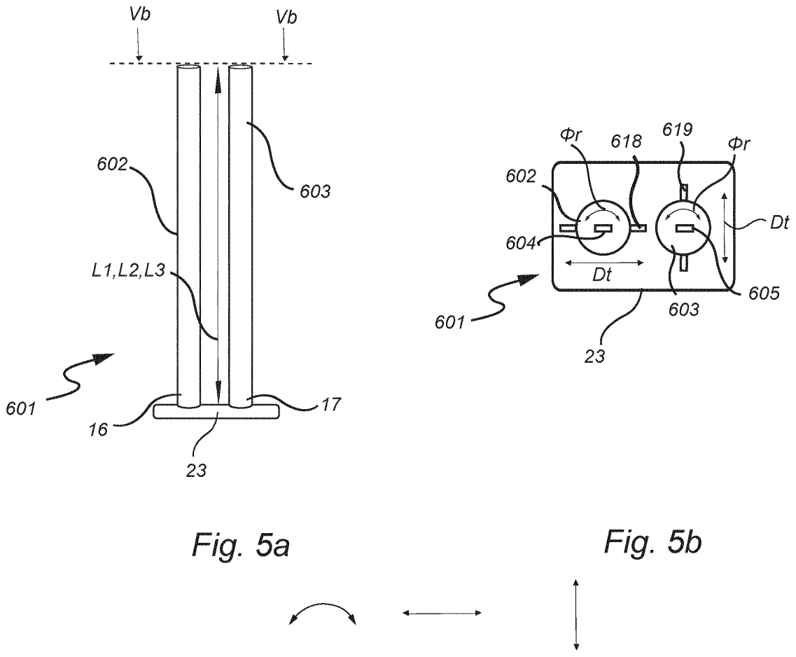

FIGS. 5a-b depicts respectively a side view and a top view of yet another embodiment of a lighting unit 601 according to the invention. In FIGS. 5a-b the lighting unit is embodied as a wall washer, is free from a housing, and the first and second elongated linear light sources 602, 603 are connected to a base support 23 by respective end portions 16, 17. Both the first and second elongated linear light sources 602, 603 are rotatable about their respective elongated extension L2, L3 over an angle in a respective rotation angle range Φᵣ, in the figure Φᵣ is about 180°. Said first and second elongated linear light sources 602, 603 are also shiftable in mutually transverse directions Dt in respective slots 618, 619 over the base support 23.

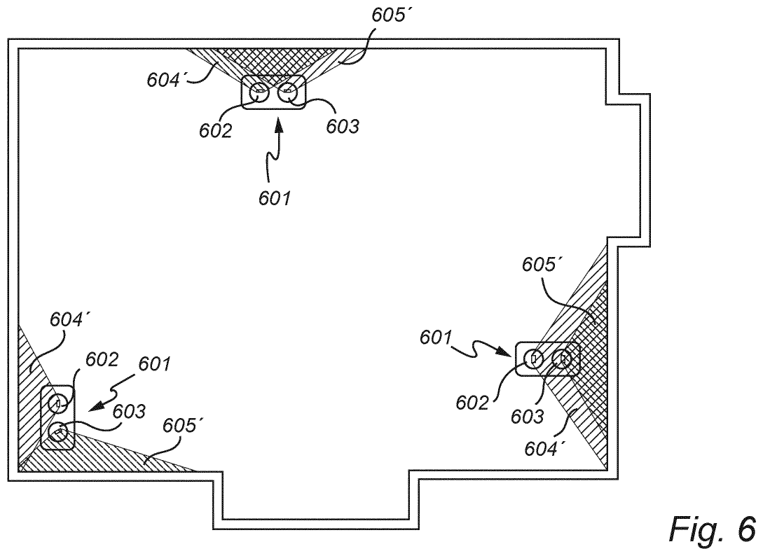

FIG. 6 illustrates a floorplan comprising a plurality of lighting units 601 as shown in FIG. 5a-b in the form of free standing wall washers arranged at different locations within the same room. Each lighting unit 601 comprises a first linear elongated light source 602 having a longitudinal extension being substantially parallel to the longitudinal extension of the linear lighting unit 601. The first linear elongated light source 602 comprises a plurality of first LEDs 604 arranged along the longitudinal extension of the first linear elongated light source 602.

The linear lighting unit 601 further comprises a second linear elongated light source 603 having a longitudinal extension being substantially parallel to the longitudinal extension of the linear lighting unit 601. It is implicitly understood that the second linear elongated light source 603 is also substantially parallel to the first linear elongated light source 602. The second linear elongated light source 603 comprises a plurality of second LEDs 605 arranged along the longitudinal extension of the second linear elongated light source 603. The plurality of first LEDs 604 is arranged to emit a beam of first light 604′. The second linear elongated light source 603 may be at least partially arranged in the beam of first light 604′ and is arranged to emit a beam of second light 605′. In other words, the second linear elongated light source 603 may be mounted in the optical path of the first light 604′ emitted by the first linear elongated light source 602. Consequently, the light from the first linear elongated light source 602 may be blocked in the angular range that is occupied by the second linear elongated light source 603. The extent of the blocked angular range depends on the size and the position of the second linear elongated light source 603.

The first and the second linear elongated light sources 602, 603 are rotatable around its respective longitudinal extension. According to such an embodiment, the user may choose to rotate the first and/or the second light sources 602, 603 such that the optical path of the first light 604 does not or hardly interfere, or interfere differently with the second light source 603, as shown in the lower left corner of FIG. 6.

Although the present invention has been described with reference to various embodiments, those skilled in the art will recognize that changes may be made without departing from the scope of the invention. It is intended that the detailed description be regarded as illustrative and that the appended claims including all the equivalents are intended to define the scope of the invention. While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A linear lighting unit having a first longitudinal extension (L1), said linear lighting unit comprising:
a housing, wherein the housing comprises an inner compartment being delimited by a base portion, a light exit window arranged at a distance from said base portion, and a wall portion connecting said base portion and said light exit window,
a first linear elongated light source extending along a second longitudinal extension (L2) being substantially parallel to said first longitudinal extension (L1), said first linear elongated light source comprising a plurality of first LEDs arranged along said second longitudinal extension (L2); and
a second linear elongated light source being spacingly arranged at a spacing(S) measured in a transverse direction (Dt) next to the first linear elongated light source and extending along a third longitudinal extension (L3) being substantially parallel to said first longitudinal extension (L1), said second linear elongated light source comprising a plurality of second LEDs arranged along said third longitudinal extension (L3);
wherein said inner compartment is arranged to accommodate said first and/or said second linear elongated light source,
wherein said first linear elongated light source is arranged to emit a beam of first light (4′) along an optical path (4″) for illumination of at least a first part of a target area,
wherein said second linear elongated light source is arranged to emit a beam of second light (5′) for illumination of at least a second part of said target area
wherein the first linear elongated light source and/or the second linear elongated light source is movable for changing a mutual position between the first and second linear elongated light source for adjustment of an illumination pattern of the illumination of said target area,
wherein, the first optical path (4″) and the second optical path (5″) are in mutual alignment and the beam of first light (4′) and/or the beam of second light (5′) are directed substantially perpendicular to the light exit window, and
wherein viewed in projection along the first longitudinal extension (L1), the second linear elongated light source is completely arranged in the beam of first light (4′).

2. The linear lighting unit as claimed in claim 1, wherein at least one of the first and second elongated light source is rotatable over its respective longitudinal extension (L2, L3).

3. The linear lighting unit as claimed in claim 1, wherein said beam of first light (4′) has a first beam angle (a) in a transverse direction (Dt) transverse to the longitudinal extension (L1), wherein 30°<=α<=180°,
wherein said beam of second light (5′) has a second beam angle (B) in said transverse direction (Dt), wherein 30°<=β<=180°, and
wherein at least one of the first and second elongated light source is rotatable within a respective rotation angle range (Φr), wherein 5°<=Φr <=180°.

4. The linear lighting unit as claimed in claim 3, wherein during operation of the linear lighting unit for any mutual rotational orientation of the first and second linear elongated light source in said rotation angle range (Φr), there is partial overlap between at least one of the beam of second light (5′) and the optical path (4″) of the beam of first light (4′) in the transverse direction (Dt).

5. The linear lighting unit as claimed in claim 1, wherein at least one of the first and second light source is shiftable in the transverse direction (Dt).

6. The linear lighting unit as claimed in claims 1, wherein mutual positions between the first and second linear light source are changeable via a shift in the transverse direction, Dt, perpendicular to the light exit window.

7. The linear lighting unit according to claim 1, wherein the second linear elongated light source has a backside which is provided with a diffuser facing the first linear elongated light source.

8. The linear lighting unit according to claim 1, wherein said beam of first light (4′) and said beam of second light (5′) mutually differ in at least one of color, color-temperature, CT, and correlated color temperature, CCT.

9. The linear lighting unit according to claim 1, wherein at least one of said plurality first LEDs and said plurality of second LEDs is color controllable.

10. (canceled)

11. The linear lighting unit according to claim 1, wherein both the first and the second linear elongated light source are arranged by a respective spacing (S1, S2) in the transverse direction (Dt) from said wall portion, and
wherein said second elongated linear light source (3) is arranged closer to said light exit window than said first elongated linear light source.

12. The linear lighting unit according to claim 1, wherein the wall portion is blocking at least one of a part of the beam of the first light (4′) and a part of the beam of second light (5′) for obtaining a desired cut-off angle or screening angle of at least one of the beam of first light and beam of second light, and/or for further control of the (mixing) of the illumination patterns of the first and second light beam.

13. The linear lighting unit according to claim 1, wherein said linear lighting unit further comprises a base support, and wherein at least one of said linear light sources comprise a respective end portion and is rotatably and/or shiftable connected to said base support via its respective end portion for enabling rotation of said light source over the respective longitudinal extension (L2, L3) and/or shift of said light source in the transverse direction (Dt).

14. The linear lighting unit according to claim 1, wherein said linear lighting unit further comprises a third linear elongated light source having a longitudinal extension being substantially parallel to said longitudinal extension (L1) of said linear lighting unit, said third linear elongated light source comprising a plurality of third LEDs arranged along said longitudinal extension of said third linear elongated light source, wherein said plurality of third LEDs is arranged to emit a beam of third light, and wherein said third linear elongated light source is at least partially arranged in said beam of said first and/or said second light.

15. The linear lighting unit according to claim 1, wherein said linear lighting unit further comprises a control unit and a detecting element arranged to provide input to said control unit.
